(19) United States
(12) Patent Application Publication
(10) Pub. No.: US 2016/0131322 A1
(43) Pub. Date: May 12, 2016

(54) Composite Lamp

(71) Applicant: SHIN YUH CHERNG IND. CO., LTD., TAINAN CITY (TW)

(72) Inventor: Hsin-Long Chen, Tainan City (TW)

(21) Appl. No.: 14/538,854

(22) Filed: Nov. 12, 2014

(51) Int. Cl. F21S 8/10

(52) U.S. Cl. CPC F21S 48/2237; F21S 48/234

(57) ABSTRACT

A composite lamp includes a base, a light-transmittable cover, a light-emitting device, a reflection seat, and a light-guiding rod. The light-emitting device includes multiple pieces of first light-emitting element and at least one piece of second light-emitting element. The reflection seat defines a reflective surface facing towards the cover and defines a rear slot and a front slot respectively facing the base and the cover. The first light-emitting elements are installed in the rear slot to face the reflective surface, so that the light emitting from the first light-emitting elements can be reflected by the reflective surface to pass through the cover. The light-guiding rod is disposed in the front slot. The second light-emitting element is adjacent to one end surface of the light-guiding rod, so that the light emitting from the second light-emitting element can enter the light-guiding rod and then pass through the cover.

### BACKGROUND OF THE INVENTION

1. Field of the Invention

The present invention relates to a composite lamp and, more particularly, to a composite lamp that can provide at least two kinds of illumination and/or alert for being applied to a vehicle.

2. Description of the Related Art

Generally, vehicles are installed with composite lamps, each of which can provide two or more kinds of illumination or alert, including backup light illumination, stop light illumination, emergency flasher warning, turn-signal light warning, tail light illumination, parking light illumination, or license plate light illumination. In other words, a composite lamp can be provided, according to a demand, with at least two functions being selected from the functions of backup light, stop light, emergency flasher, turn-signal light, tail light, parking light, and license plate light.

A conventional composite lamp for vehicles generally includes a transparent cover, a base, at least two light sources, and a reflector. The base has a front opening being sealed by cover. The reflector has a bowl-shaped reflective surface, which defines a wide opening and is treated with an electrically plated layer, so that the light emitting from the light sources can be reflected by the reflective surface to pass through the transparent the cover. The light sources can be light-emitting diodes or light bulbs, which are installed at an inner bottom of the reflector to face towards the cover, so that portion of the light rays emitting from the light sources can be reflected by the reflective surface to pass through the cover. However, portion of the light rays emitting from the light sources can directly go through the cover, which may cause a blinding effect on approaching drivers, and can form a extremely bright spot and thus produce a non-uniform illumination. In addition, for effectively making use of the light emitting from the light sources, the depth of the reflector should be increased. However, this will increase the volume and cost of the composite lamp. In other words, if the depth of the reflector is not increased, the light emitting from the light sources will not be reflected effectively.

### BRIEF SUMMARY OF THE INVENTION

Thus, an objective of the present invention is to provide a composite lamp, which can provide at least two kinds of illumination and/or alert for being applied to a vehicle. Furthermore, the light emitting from the composite lamp can be effectively reflected to produce a uniform illumination, and further, the volume of the composite lamp can be reduced, compared with conventional lamps.

To achieve this and other objectives, a composite lamp of the present invention includes a base, a light-transmittable cover, a light-emitting device, a reflection seat, and a light-guiding rod. The base is adapted for mounting to a vehicle and includes a front opening. The light-transmittable cover is fitted to the base to seal the front opening of the base, and a chamber is formed between the light-transmittable cover and the base. The light-emitting device is arranged in the chamber and includes a plurality of first light-emitting elements and at least one piece of second light-emitting element. The first light-emitting elements and the at least one piece of second light-emitting element are individually controlled to emit light. The reflection seat is arranged in the chamber of the base and includes a curved reflective surface facing towards the light-transmittable cover. The reflection seat further includes a rear slot and a front slot respectively facing the base and the light-transmittable cover. The reflection seat further includes a plurality of through-holes communicating with the rear slot. The first light-emitting elements are installed in the rear slot and face towards the reflective surface. The light emitting from each of the first light-emitting elements goes through one of the through-holes to be incident on and reflected by the reflective surface to pass through the light-transmittable cover. The light-guiding rod is disposed in the front slot of the reflection seat. The at least one piece of second light-emitting element is adjacent to one end surface of the light-guiding rod. The light emitting from the second light-emitting element enters the light-guiding rod via the end surface and then sent out from the light-guiding rod to pass through the light-transmittable cover.

In a preferred form, the light-emitting device is arranged in the chamber through an electrical board assembly including a top board, a bottom board spaced apart from the top board, and two side boards respectively at two sides of the top and bottom boards. The first light-emitting elements are light-emitting diodes and provided on a top surface of the top board and a bottom surface of the bottom board. The at least one piece of second lighting element includes two pieces of the second light-emitting element respectively provided on inner surfaces of the two side boards. The light-guiding rod is located between the two pieces of the second light-emitting elements.

In a preferred form, the reflection seat is provided with two spaced-apart partition walls at its middle. The front and rear slots are defined between the partition walls, and the through-holes is defined in the partition walls. The reflection seat is a curved body with a periphery, and the curved reflective surface is formed at an inner bottom of the curved body. The reflection seat has a plurality of partitioning plates joined between the partition walls and the periphery. Two adjacent ones of the through-holes in the partition walls are isolated by one of the partitioning plates.

In a preferred form, the light-guiding rod is provided with a plurality of first steps, and the reflection seat is provided with a plurality of second steps corresponding to the first steps; The light-guiding rod is firmly disposed in the front slot by engagement of the first and second steps.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 is a perspective view of a composite lamp in accordance with an embodiment of the present invention.

FIG. 2 shows an exploded view of the composite lamp of FIG. 1.

FIG. 3 shows another exploded view of the composite lamp of FIG. 1.

FIG. 4 shows a sectional view taken along line 4-4 in FIG. 1.

FIG. 5 shows a partially enlarged view of FIG. 4.

FIG. 6 shows a sectional view taken along line 6-6 in FIG. 1.

FIG. 7 shows a 3-dimensional sectional view of the composite lamp of FIG. 1.

FIG. 7a shows a partially enlarged view of a circled portion in FIG. 7.

### DETAILED DESCRIPTION OF THE INVENTION

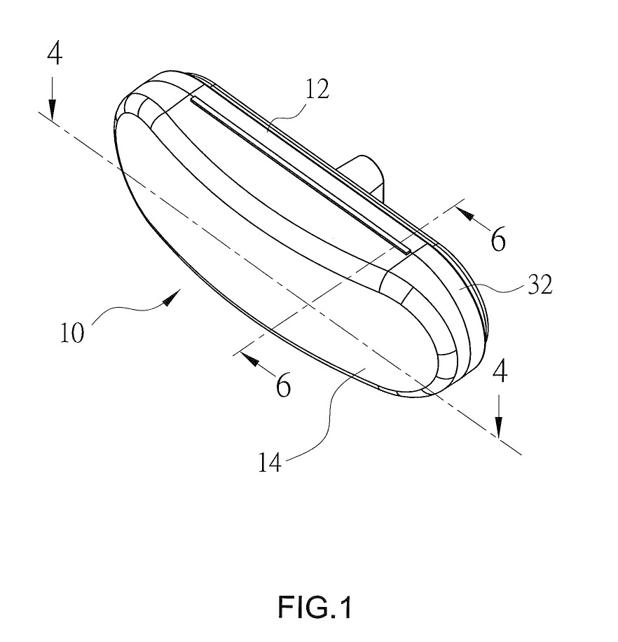

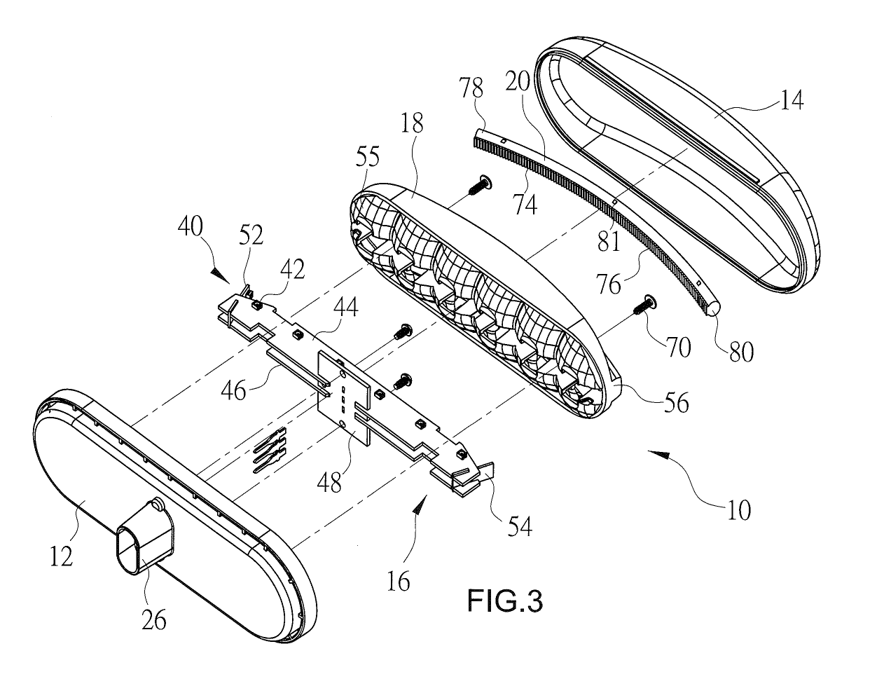

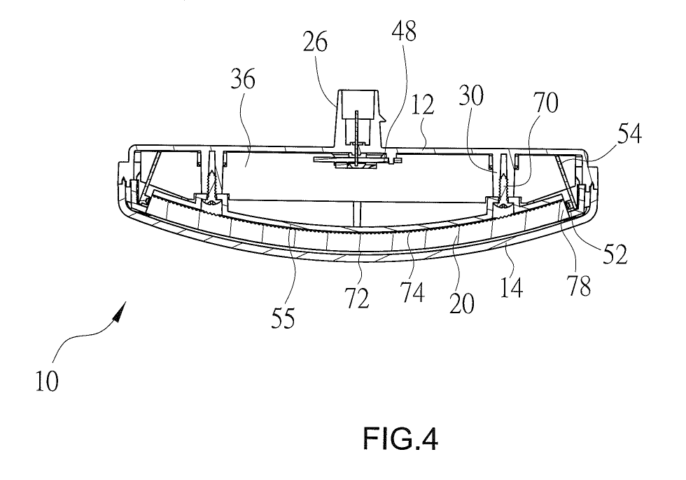

A composite lamp according to the preferred teachings of the present invention is shown in FIGS. 1 through 7 of the drawings and generally designated 10. The composite lamp 10 is adapted to be mounted to a piece of transportation equipment, such as a vehicle, for providing illumination and/or alert. The composite lamp 10 generally includes a base 12, a light-transmittable cover 14, a light-emitting device 16, a reflection seat 18, and a light-guiding rod 20. In the embodiment, the base 12 has an opening 22 at its front and a mounting portion 26 at its rear. The mounting portion 26 extends rearwardly for being connected to one vehicle. An inner surface 24 of the base 12 is provided with a plurality of combining portions 28 and a plurality of combining posts 30 for allowing the light-emitting device 16 and the reflection seat 18 to be combined with the base 12. Furthermore, the base 12 has a circumferential edge 32, in which a groove 34 is defined for engaging with the edge of the light-transmittable cover 14. The light-transmittable cover 14 can be fitted to the base 12 to seal the front opening 22, and a chamber 36 is formed between the light-transmittable cover 14 and the base 12 for accommodating the light-emitting device 16, the reflection seat 18, and the light-guiding rod 20.

The light-emitting device 16, which is arranged in the chamber 36, includes a first lighting group 38 and a second lighting group 40. The first lighting group 38 includes a plurality of first light-emitting elements 42. In the embodiment, the first light-emitting elements 42 are light emitting diodes. The light-emitting device 16 is installed through an electrical board assembly including a main board 48, a top board 44 attached to the main board 48, a bottom board 46 attached to the main board 48 and spaced apart from the top board 44, and two side boards 54 at two sides of the top and bottom boards 44 and 46 and attached thereto. The electrical board assembly can be fixed to the base 12 by inserting screws 50 through the main board 48 to engage with the combining portions 28 of the base 12. In the embodiment, the first light-emitting elements 42 are provided on a top surface of the top board 44 and a bottom surface of the bottom board 46. The second lighting group 40 includes at least one piece of second light-emitting element 52. In the embodiment, the second lighting group 40 includes two pieces of the second light-emitting element 52, which are light-emitting diodes. The second light-emitting elements 52 are respectively provided on inner surfaces of the two side boards 54. Furthermore, the first light-emitting elements 42 and the second light-emitting elements 52 are electrically connected to the main board 48, so that the first and second light-emitting elements 42 and 52 can be controlled individually to emit light. Thus, the composite lamp 10 can afford two kinds of illumination or two kinds of alert, or both illumination and alert. In the embodiment, the first lighting group 38 can work as a light source of a tail light, a stop light, or a turn-signal light; the second lighting group 40 can work as a light source of a parking light.

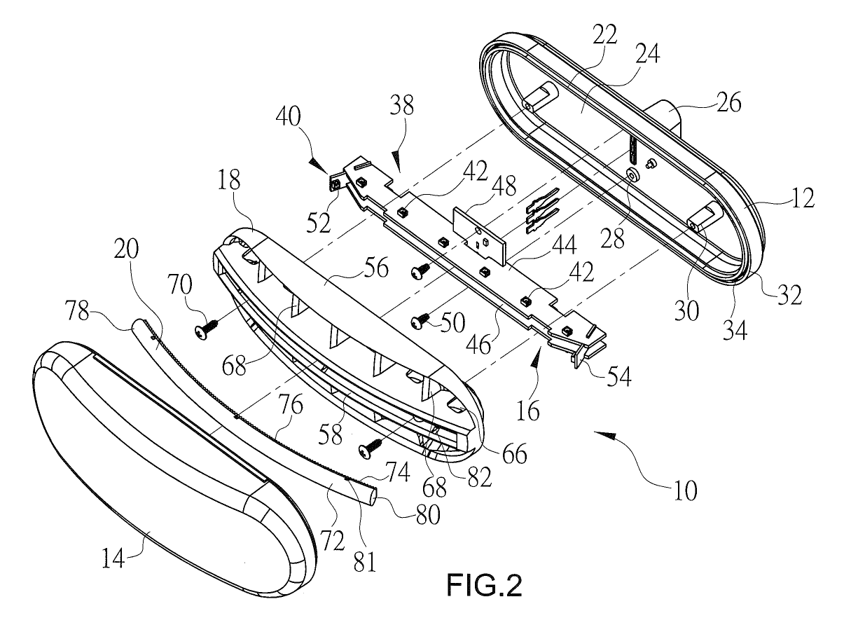

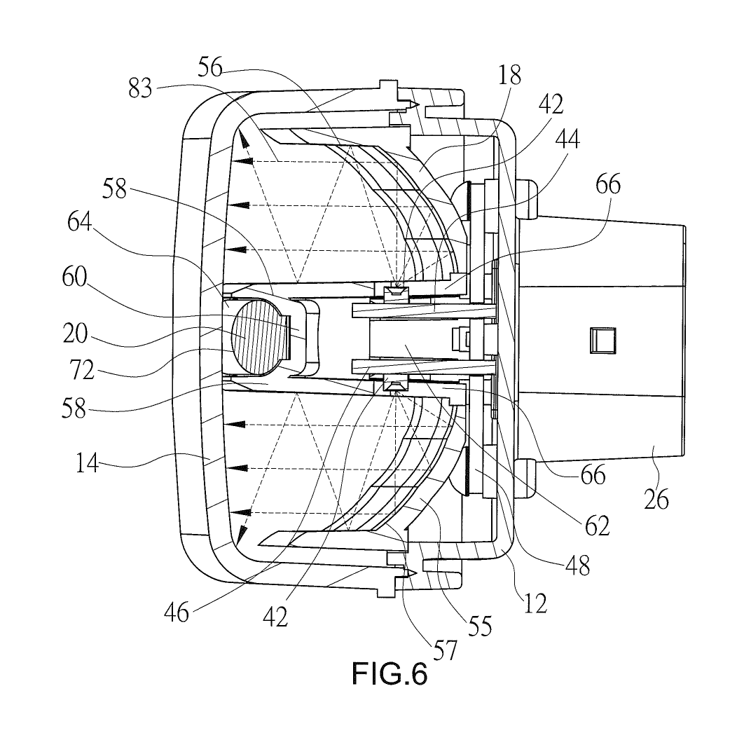

The reflection seat 18, which is shown as a curved body 55 with a periphery 56 and is arranged in the chamber 36, has a generally C-shaped cross section (FIG. 6). The reflection seat 18 has a curved reflective surface 57 at an inner bottom of the curved body 55, which faces towards the light-transmittable cover 14. The reflective surface 57 can be included of multiple concave surfaces to increase the reflection effect. Furthermore, the reflection seat 18 is provided with two spaced-apart partition walls 58 extending longitudinally at its middle and spaced from the periphery 56. Furthermore, a connecting wall 60 is provided between the partition walls 58 to divide a space between the walls 58 into a rear slot 62 and a front slot 64 respectively facing towards the base 12 and the light-transmittable cover 14 (FIG. 6). The rear slot 62 is used for accommodating the light-emitting device 16. The two partition walls 58 define a plurality of through-holes 66 (see FIG. 2). A plurality of partitioning plates 68 are joined between the partition walls 58 and the periphery 56, so that two adjacent through-holes 66 can be isolated by one of the partitioning plates 68. Furthermore, the first light-emitting elements 42 of the first lighting group 38 are arranged corresponding to the through-holes 66 and facing towards the reflective surface 57. Each of the second light-emitting elements 52 of the second lighting group 40 is inserted through the rear slot 62 along one side thereof to approach the front slot 64 to be adjacent to the light-guiding rod 20, as will be fully described below. As such, the light emitting from each of the first light-emitting elements 42 can go through one of the through-holes 66 to be incident on the reflective surface 57, so that the light can be reflected by the reflective surface 57 to pass through the light-transmittable cover 14 (see FIG. 6). In the embodiment, the reflection seat 18 can be fixed to the base 12 by inserting screws 70 through the curved body 55 thereof to engage with the central holes of the combining posts 30.

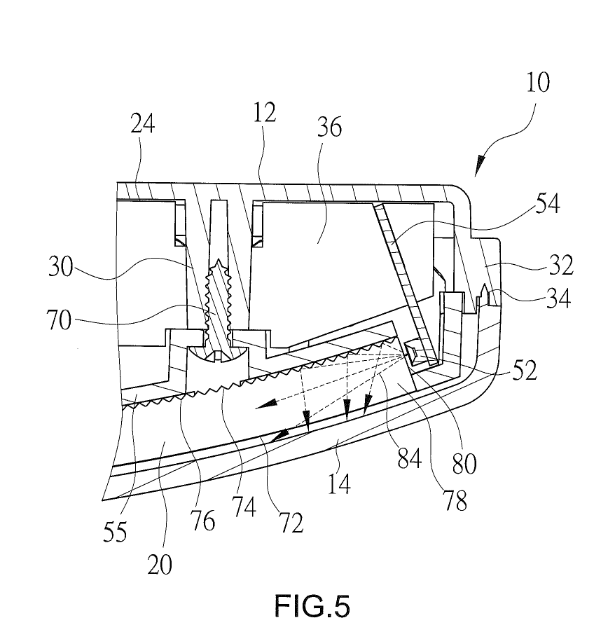

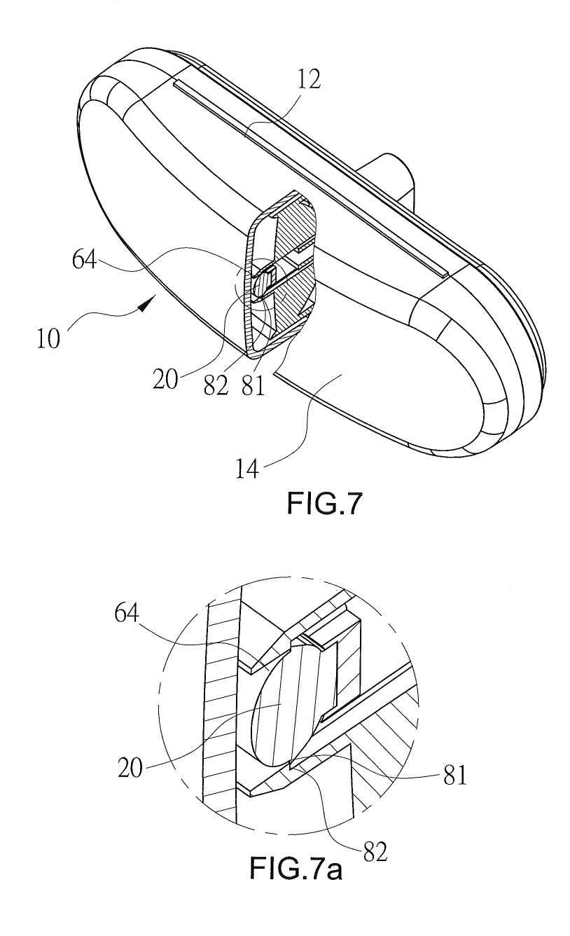

The light-guiding rod 20 disposed in the front slot 64 of the reflection seat 18 has a first surface 72 and a second surface 74 opposite to the first surface 72. In the embodiment, the first surface 72 is configured as an arc-shaped surface through which light can be sent out (see FIG. 6). The second surface 74 is configured as a flat surface with a portion 76 of serrated microstructure to increase the uniformity of the light being sent out from the first surface 72 of the light-guiding rod 20 (see FIG. 5). In the embodiment, the light-guiding rod 20 is located between the two pieces of the second light-emitting element 52, wherein end surfaces 80 of two ends 78 of the light-guiding rod 20 are respectively adjacent to the second light-emitting elements 52, so that the light emitting from the second light-emitting elements 52 can go into the light-guiding rod 20 respectively via the end surfaces 80, and then the light can be reflected by the second surface 74 to go out of the light-guiding rod 20 and pass through the light-transmittable cover 14. Furthermore, the light-guiding rod 20 can be provided with a plurality of first steps 81 (see FIGS. 2, 7 and 7a), and the opposite partition walls 58 can be provided with a plurality of second steps 82 corresponding to the first steps 81, so that the light-guiding rod 20 can be firmly disposed to the reflection seat 18 by engagement of the first and second steps 81 and 82.

In use, the composite lamp 10 can provide two kinds of illumination and/or alert, wherein the light emitting from the first light-emitting elements 42 is not directly aimed at the light-transmittable cover 14. As mentioned above, the first light-emitting elements 42 are arranged to face the reflective surface 57 of the reflection seat 18 (see FIG. 6), so that the light emitting from the first light-emitting elements 42 can be incident on and, reflected by the reflective surface 57 to pass through, the light-transmittable lens 14, as shown by reference numeral 83 in FIG. 6, so as to achieve a wide-angle illumination effect. In an application, the first lighting group 38 can serve as a light source of a tail light, a stop light, or a turn-signal light. Furthermore, the light emitting from the second light-emitting elements 52 is not directly aimed at the light-transmittable cover 14. As mentioned above, the second light-emitting elements 52 are arranged to face the end surfaces 80 of the light-guiding rod 20, so that the light emitting from the second light-emitting elements 52 can go into the light-guiding rod 20 via the end surfaces 80. Most of the light will be reflected by the second surface 74 of the light-guiding rod 20 to go out of the first surface 72, as shown by reference numeral 84 in FIG. 5, and then pass through the light-transmittable cover 14, so that the second light-emitting elements 52 can produce a more uniform illumination. Therefore, the second light-emitting elements 52 can serve as a light source of a parking light or front position light.

As described above, the second light-emitting elements 52, which emit light to enter the light-guiding rod 20 via the end surfaces 80, can serve as a light source of a parking light or front position light. As such, the number of the second light-emitting elements 52 can be reduced. Furthermore, the light emitting from the first and second lighting groups 38 and 40 is not directly aimed at the light-transmittable cover 14, so that the light will not cause a blinding effect on approaching drivers. In addition, through reflection, the illumination effect of the first and second light-emitting elements 42 and 52 can be significantly improved, so that the depth of the reflection seat 18 can be reduced and thus the volume of the composite lamp 10 can be reduced.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A composite lamp, comprising:
a base adapted for mounting to a vehicle and having a front opening;
a light-transmittable cover fitted to the base to seal the front opening of the base, with a chamber formed between the light-transmittable cover and the base;
a light-emitting device arranged in the chamber and including a plurality of first light-emitting elements and at least one piece of second light-emitting element, with the first light-emitting elements and the at least one piece of second light-emitting element individually controlled to emit light;
a reflection seat arranged in the chamber of the base and including a curved reflective surface facing towards the light-transmittable cover, with the reflection seat further including a rear slot and a front slot respectively facing the base and the light-transmittable cover, with the reflection seat further including a plurality of through-holes communicating with the rear slot, with the first light-emitting elements installed in the rear slot and facing towards the reflective surface, with the light emitting from each of the first light-emitting elements going through one of the through-holes to be incident on and reflected by the reflective surface to pass through the light-transmittable cover; and
a light-guiding rod disposed in the front slot of the reflection seat, with the at least one piece of second light-emitting element being adjacent to one end surface of the light-guiding rod, with the light emitting from the at least one piece of second light-emitting element entering the light-guiding rod via the end surface and then sent out from the light-guiding rod to pass through the light-transmittable cover.

2. The composite lamp of claim 1, wherein the light-emitting device is arranged in the chamber through an electrical board assembly including a top board, a bottom board spaced apart from the top board, and two side boards respectively at two sides of the top and bottom boards, with the first light-emitting elements being light-emitting diodes provided on a top surface of the top board and a bottom surface of the bottom board, with the at least one piece of second lighting element including two pieces of the second light-emitting element respectively provided on inner surfaces of the two side boards, with the light-guiding rod located between the two pieces of the second light-emitting elements.

3. The composite lamp of claim 1, wherein the reflection seat is provided with two spaced-apart partition walls at its middle, with the front and rear slots defined between the partition walls, with the through-holes defined in the partition walls.

4. The composite lamp of claim 3, wherein the reflection seat is a curved body with a periphery, with the reflective surface formed at an inner bottom of the curved body, with the reflection seat provided with a plurality of partitioning plates joined between the partition walls and the periphery, with two adjacent ones of the through-holes in the partition walls isolated by one of the partitioning plates.

5. The composite lamp of claim 1, wherein the light-guiding rod is provided with a plurality of first steps, with the reflection seat provided with a plurality of second steps corresponding to the first steps, with the light-guiding rod firmly disposed in the front slot by engagement of the first and second steps.
